(19) United States
(12) Patent Application Publication
(10) Pub. No.: US 2021/0161629 A1
(43) Pub. Date: Jun. 3, 2021

(54) Arbitrarily-Bendable Oral Irrigator Nozzle and Oral Irrigator

(71) Applicant: Aboel Electronic Technology (Shenzhen) Co., Ltd, Shenzhen (CN)

(72) Inventor: Xianhua Huang, Shenzhen (CN)

(21) Appl. No.: 16/726,819

(22) Filed: Dec. 24, 2019

(30) Foreign Application Priority Data
Dec. 2, 2019 (CN) 201922139996.5

(51) Int. Cl. A61C 17/02

(52) U.S. Cl. CPC A61C 17/0202

(57) ABSTRACT

An arbitrarily-bendable oral irrigator nozzle is connected to an oral irrigator in use and comprises a base which is made from hard materials and provided with a water channel used for guiding water in the oral irrigator to spray, wherein a sleeve made from silica gel wraps the base and is internally provided with a water outlet channel communicated with the water channel; and a bendable metal part is embedded into the sleeve along the water outlet channel and has a first end fixedly connected to the base, and the metal part abuts against the sleeve to form a bendable and shapeable structure. The sleeve made from the silica gel wraps the base and is provided with the water outlet channel communicated with the water channel to form a flexible bendable part, and a metal wire is embedded into the sleeve and has one end fixed to the base.

### CROSS REFERENCE TO RELATED APPLICATIONS

The present application claims the benefit of Chinese Patent Application No. 201922139996.5 filed on Dec. 2, 2019, the contents of which are incorporated herein by reference in their entirety.

### BACKGROUND OF THE INVENTION

### Technical Field

The application relates to the technical field of nozzle fittings of oral irrigators, in particular to an arbitrarily-bendable oral irrigator nozzle and an oral irrigator.

### Description of Related Art

Tooth cleaning as a health item is increasingly receiving more and more attention of people at present. Thus, various tooth cleaning tools are emerging. There is an oral irrigator (also called domestic water toothpick, electrical water flosser, portable dental cleaner, or dental scaler) used for washing gaps between teeth by means of a high-pressure water current. The primary principle of the oral irrigator is that dental plaque and food residues under gum lines are removed by means of flowing pulse water to improve gum health. Compared with common toothbrushes, the oral irrigator is more effective in treating dental plaque, gingivitis, and the like. Most existing toothbrushes cannot let toothpaste enter gaps, slots, and cracks of occlusal surfaces, while 80% tooth decay occurs at these places. The oral irrigator can let water or liquid medicines enter the gaps of the occlusal surfaces to neutralize acidic substances in the gaps and restore the calcium content of dental enamels which have been decalcified originally. Clearly, better cleaning effects can be fulfilled by increasing the pressure of high-pressure water.

However, most existing oral irrigator nozzles are designed to be of a rigid structure and have a fixed bending angle, thereby being unable to clean teeth at different positions. Users generally do not purchase oral irrigator nozzles having different bending angles at the same time to clean teeth. Thus, there is an urgent need on the market for an oral irrigator nozzle which is more ingenious in structure.

### BRIEF SUMMARY OF THE INVENTION

The objective of the application is to solve the problem, mentioned in the description of related art, that the angle of oral irrigator nozzles in the prior art cannot be arbitrarily adjusted by providing an arbitrarily-bendable oral irrigator nozzle and an oral irrigator using the same to make sure that users can arbitrarily adjust the bending angle of the nozzle to clean any positions, so that the user experience is high, and using is convenient.

To fulfill the above-mentioned objective, the application provides an arbitrarily-bendable oral irrigator nozzle which is connected to an oral irrigator used to guide water in the oral irrigator to spray. The arbitrarily-bendable oral irrigator nozzle comprises a base which is made from hard materials and is provided with a water channel used for guiding the water in the oral irrigator to spray as well as a sleeve which is made from silica gel, is connected to the base, and is internally provided with a water outlet channel abutting against the water channel, wherein at least one bendable metal part is embedded into the sleeve along the water outlet channel and has a first end fixedly connected to the base, and the metal part abuts against the sleeve to form a bendable and shapeable structure.

Preferably, one end of the sleeve wraps the base, and the water channel abuts against the water outlet channel, so that a water-proof structure is formed.

Preferably, the arbitrarily-bendable oral irrigator nozzle further comprises a spray head which is made from hard materials and formed with a water outlet communicated with the water outlet channel, wherein a second end of the metal part is fixedly connected to the spray head, and the water outlet restricts the water spray direction and diameter.

Preferably, the internal diameter of the water outlet is gradually decreased in a water direction.

Preferably, the sleeve wraps the spray head and is formed with a through hole as large as the water outlet.

Preferably, the diameter of the water outlet is 0.6-1 mm.

Preferably, the water outlet channel is able to at least withstand an impulsive force of 120 PSI.

Preferably, the metal part is an iron wire, the number of the iron wire is one, and the diameter of the iron wire is 0.7-1.8 mm.

The application further provides an oral irrigator which comprises a shell, wherein a water tank provided with a water pipe and a high-pressure pump connected to the water tank are received in the shell; the oral irrigator further comprises the arbitrarily-bendable oral irrigator nozzle in the above technical solution; and the base is connected to the shell, and the water pipe is communicated with the water channel.

In the prior art, oral irrigator nozzles are made from hard materials and have been designed to have a certain bending angle to meet the user requirements. However, due to the fact that the bending angle is fixed, cleaning positions cannot be arbitrary adjusted, and consequentially, existing oral irrigators cannot meet the requirements of users for angle adjustment during cleaning.

The arbitrarily-bendable oral irrigator nozzle provided by the application is connected to the oral irrigator in use to guide the water in the oral irrigator to spray and comprises the base which is made from the hard materials and provided with the water channel used for guiding the water in the oral irrigator to spray, wherein the sleeve made from the silica gel wraps the base and is internally provided with the water outlet channel communicated with the water channel; and at least one bendable metal part is embedded into the sleeve along the water outlet channel and has the first end fixedly connected to the base, and the metal part abuts against the sleeve to form the bendable and shapeable structure. The base is made from the hard materials and wrapped with the sleeve made from the silica gel to be stably connected to an external water supply structure and is provided with the water outlet channel communicated with the water channel to form a flexible bendable part, and a metal wire is embedded into the sleeve and has one end fixed to the base, so that the sleeve is bent synchronously when the metal wire is bent, and the metal wire will not restore after being bent, so that the sleeve is synchronously shaped, and thus, the oral irrigator nozzle can be arbitrarily bent by an angle to clean teeth.

### BRIEF DESCRIPTION OF THE SEVERAL VIEWS OF THE DRAWINGS

FIG. 1 is a perspective view of the application in an unfolded state;

FIG. 2 is an exploded view of the application;

FIG. 3 is a sectional view of the application;

FIG. 4 is a structural view of a metal part, a base, and a spray head of the application.

### REFERENCE SIGNS

1, base; 11, water channel; 2, sleeve; 21, water outlet channel; 22, metal part; 3, spray head; 31, water outlet.

### DETAILED DESCRIPTION OF THE INVENTION

The application is further expounded below in combination with the accompanying drawings to be described more clearly.

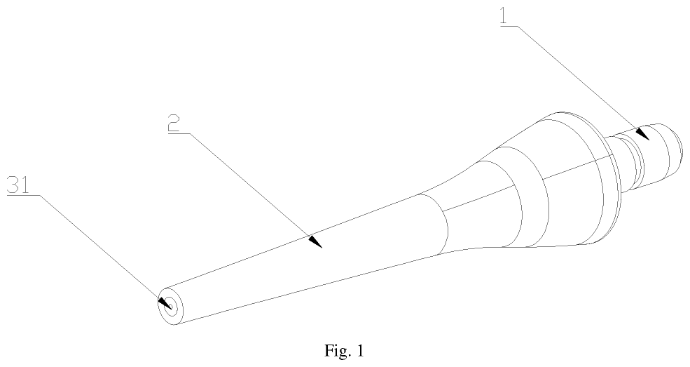

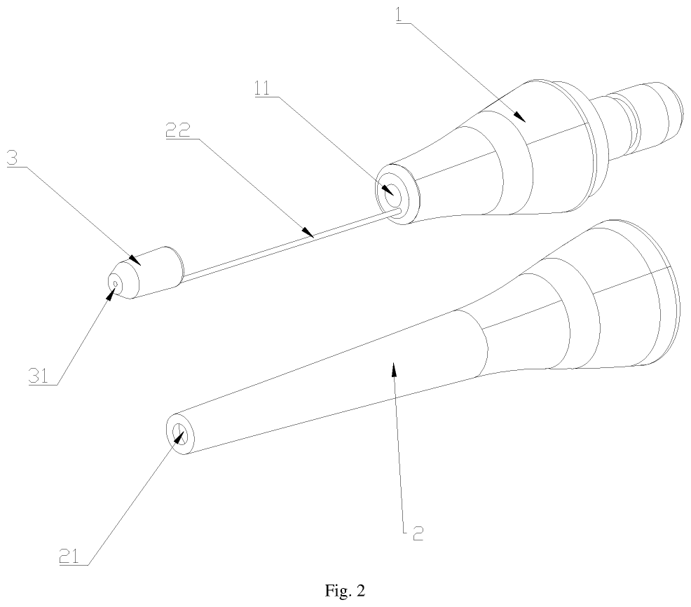

Referring to FIG. 1 to FIG. 2, an arbitrarily-bendable oral irrigator nozzle is connected to an oral irrigator used to guide water in the oral irrigator to spray and comprises a base made from hard materials which include hard plastics, stainless steel, and the like, and the hard materials are preferably the hard plastics having low costs and performance meeting the use requirements. The base 1 is provided with a water channel 11 used for guiding the water in the oral irrigator to spray and is clamped with a water supply part to receive water which in turn flows into the water channel, the water supply part is composed of a water pump and a water tank of an oral irrigator on the market, and even a water gun can be connected to the base to supply water. The arbitrarily-bendable oral irrigator nozzle further comprises a sleeve 2 which is made from silica gel, is connected to the base 1, and is internally provided with a water outlet channel 21 abutting against the water channel 11, wherein at least one bendable metal part 22 is embedded into the sleeve 2 along the water outlet channel 21 and has a first end fixedly connected to the base 1, and the metal part 22 abuts against the sleeve 2 to form a bendable and shapeable structure. The bendable metal part is shaped after being bent, and the sleeve made from silica gel can restore after being bent; in view of this, the bendable metal part is adopted to hinder the restoring force of the silica gel sleeve and has one end fixed to the base, so that falling of the bendable metal part is prevented; in addition, the bendable metal part is embedded into the sleeve to be prevented from making contact with outside air and water in a pipe, thus being prevented against rustiness and corrosion; and although the metal part can be arranged on the surface of the silica gel sleeve to be restricted in shape, in consideration of attractive appearance and performance, the metal part is preferably embedded into the sleeve.

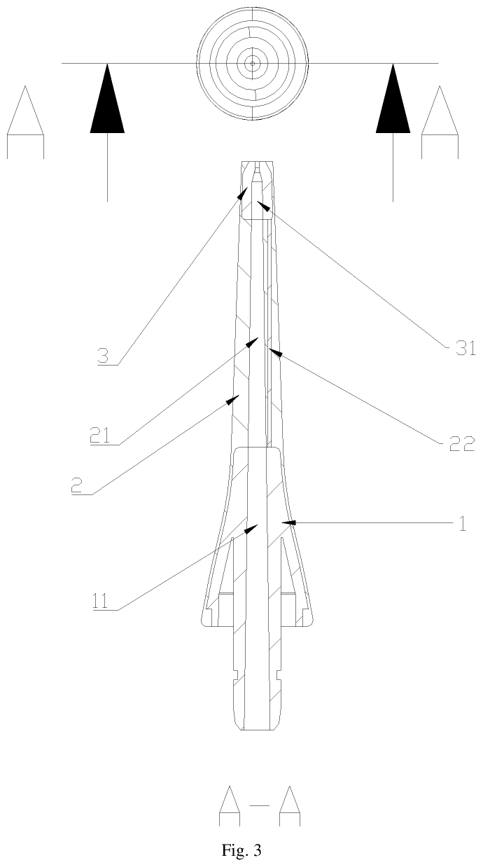

Preferably, referring to FIG. 3, one end of the sleeve 2 wraps the base 1, and the water channel 11 abuts against the water outlet channel 21, so that a water-proof structure is formed. Because the sleeve is a silica gel structure and the base is a hard structure, if the sleeve and the base are bonded merely, a water leakage may occur. Thus, the base is preferably wrapped with the sleeve, so that the water leakage is prevented, and the appearance is more attractive.

In this embodiment, referring to FIG. 2, the arbitrarily-bendable oral irrigator nozzle further comprises a spray head 3 which is made from hard materials and formed with a water outlet 31 communicated with the water outlet channel 21, wherein a second end of the metal part 22 is fixedly connected to the spray head 3, and the water outlet 31 restricts the water spray direction and diameter. Because the outlet of the water outlet channel cannot be well restricted if the metal part is merely embedded into the sleeve and has one end fixed to the base, in order to better restrict the flow direction and rate of water out of the water outlet channel, the spray head made from the hard materials is arranged at the tail end of the water outlet channel; and the water outlet communicated with the water outlet channel is formed in the spray head and can also restrict the flow direction and rate of water flowing through the entire water outlet, so that the normal of sprayed water is kept parallel to the water outlet all the time. Preferably, in order to make sure that the sprayed water has certain pressure and cleaning capacity, the internal diameter of the water outlet is gradually decreased in the water direction; and the diameter range of the water outlet is 0.6-1 mm.

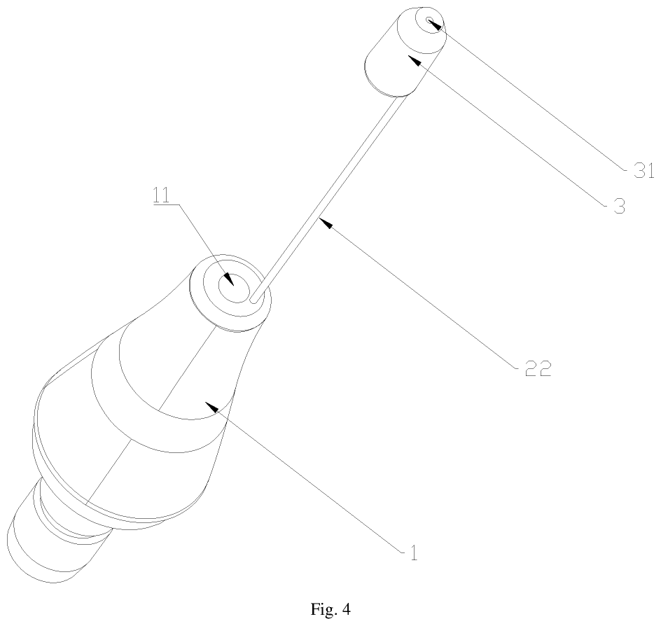

Of course, referring to FIG. 3 and FIG. 4, just like the base is wrapped in the sleeve, the spray head 3 is wrapped with the sleeve 2 which is formed with a through hole as large as the water outlet 31, so that an integral structure is formed completely, the attractive appearance is fulfilled, the structural rigidity is improved, and the operational performance is guaranteed. When a material used for making the sleeve is selected, the selected silica gel should be able to at least withstand an impulsive force of 120 PSI. With regard to silica gel products which generally can withstand a pressure between 2.5 Mpa and 4 Mpa, such pressure requirement can be easily met.

For the sake of convenient usage and fabrication, the metal part can be, but is not limited to, a copper wire, an iron wire, a steel wire, or an alloy wire and is preferably the iron wire, the number of the iron wire is one, the diameter of the iron wire is 07-1.8 mm and is preferably 1 mm, and the iron wire is produced by means of a simple process, is applied widely, and has been developed early. The iron wire or steel wire is obtained through cold machining on an iron or steel wire rod and is typically made from optimal carbon steel or stainless steel. Generally, an iron ingot (steel ingot) used for fabricating the iron wire (steel wire) can be produced through a plurality of procedures such as wire rod shelling, pickling, washing, saponification, drying, drawing, annealing, cooling, pickling washing, wire galvanization, and packaging, so that good stability and corrosion prevention are fulfilled. The iron wire as a common metal wire can be used for at least six months if the iron wire is through a back-and-forth bending test method of a metal wire of 1 mm at a time interval of two times every day according to a daily use habit; the bending angle of the iron wire will not be extremely large under the buffer action of the plastic sleeve; the iron wire has a limited internal energy increase and a long service life, and is economical, practical, and easy to use compared with other metal wires.

An oral irrigator provided with the arbitrarily-bendable oral irrigator nozzle comprises a shell, wherein a water tank provided with a water pipe and a high-pressure pump connected to the water tank are received in the shell, and the high-pressure pump pumps and sprays water from the water tank to clean teeth; and the base is connected to the shell, and the water pipe is communicated with the water channel. Thus, the oral irrigator using the arbitrarily-bendable oral irrigator nozzle of this application can be arbitrarily bent to an angle required by users to spray water to clean the teeth.

The application has the following advantages:

(1) The nozzle can be adjusted to a bending angle required by the users to accurately clean oral cavities; and

(2) The metal part is wrapped in the sleeve to be prevented from making contact with the external environment, thus being prevented against rustiness and displacement after long-term usage and having high structural rigidity.

Only one or several specific embodiments of the application are disclosed above, and the application is not limited to the above embodiments. All changes which can be conceived by those skilled in the art should also fall within the protection scope of the application.

What is claimed is:

1. An arbitrarily-bendable oral irrigator nozzle, being connected to an oral irrigator used to guide water in the oral irrigator to spray, and comprising a base which is made from hard materials and is provided with a water channel used for guiding the water in the oral irrigator to spray, as well as a sleeve which is made from silica gel, is connected to the base, and is internally provided with a water outlet channel abutting against the water channel, wherein at least one bendable metal part is embedded into the sleeve along the water outlet channel and has a first end fixedly connected to the base, and the metal part abuts against the sleeve to form a bendable and shapeable structure.

2. The arbitrarily-bendable oral irrigator nozzle according to claim 1, wherein one end of the sleeve wraps the base, and the water channel abuts against the water outlet channel, so that a water-proof structure is formed.

3. The arbitrarily-bendable oral irrigator nozzle according to claim 1, wherein the arbitrarily-bendable oral irrigator nozzle further comprises a spray head which is made from hard materials and formed with a water outlet communicated with the water outlet channel, wherein a second end of the metal part is fixedly connected to the spray head, and the water outlet restricts a water spray direction and diameter.

4. The arbitrarily-bendable oral irrigator nozzle according to claim 3, wherein an internal diameter of the water outlet is gradually decreased in a water direction.

5. The arbitrarily-bendable oral irrigator nozzle according to claim 3, wherein the sleeve wraps the spray head and is formed with a through hole as large as the water outlet.

6. The arbitrarily-bendable oral irrigator nozzle according to claim 5, wherein a diameter of the water outlet is 0.6-1 mm.

7. The arbitrarily-bendable oral irrigator nozzle according to claim 1, wherein the water outlet channel is able to at least withstand an impulsive force of 120 PSI.

8. The arbitrarily-bendable oral irrigator nozzle according to claim 1, wherein the metal part is an iron wire, the number of the iron wire is one, and a diameter of the iron wire is 0.7-1.8 mm.

9. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 1, the base is connected to the shell, and the water pipe is communicated with the water channel.

10. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 2, the base is connected to the shell, and the water pipe is communicated with the water channel.

11. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 3, the base is connected to the shell, and the water pipe is communicated with the water channel.

12. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 4, the base is connected to the shell, and the water pipe is communicated with the water channel.

13. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 5, the base is connected to the shell, and the water pipe is communicated with the water channel.

14. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 6, the base is connected to the shell, and the water pipe is communicated with the water channel.

15. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 7, the base is connected to the shell, and the water pipe is communicated with the water channel.

16. An oral irrigator, comprising a shell, wherein a water tank provided with a water pipe and a high-pressure pump connected to the water tank are received in the shell, the oral irrigator further comprises the arbitrarily-bendable oral irrigator nozzle according to claim 8, the base is connected to the shell, and the water pipe is communicated with the water channel.
